(19) United States
(12) Patent Application Publication
(10) Pub. No.: US 2026/0244939 A1
(43) Pub. Date: Aug. 20, 2026

(54) PRESENT BIAS ANALYSIS DEVICE, METHOD AND PROGRAM

(71) Applicant: NTT, Inc., Tokyo (JP)

(72) Inventors: Shuhei YAMAMOTO, Musashino-shi (JP); Takeshi KURASHIMA, Musashino-shi (JP); Tomu TOMINAGA, Musashino-shi (JP)

(73) Assignee: NTT, Inc., Tokyo (JP)

(21) Appl. No.: 19/161,751

(22) PCT Filed: Mar. 14, 2023
(86) PCT No.: PCT/JP2023/009920

§ 371 Date: Sep. 3, 2025

(51) Int. Cl. G06N 3/091

(52) U.S. Cl. CPC G06N 3/091

(57) ABSTRACT

According to one aspect of the embodiments, a method includes acquiring vital data, behavior data, and task data over a predetermined period of users to be learned from a learning data storage unit and performing predetermined preprocessing on each of the acquired vital data, the acquired behavior data, and the acquired task data. The method includes generating feature data regarding the users to be learned by combining the preprocessed vital data, the preprocessed behavior data, and the preprocessed task data of the same users to be learned while aligning time-series positions. The method includes generating a learned analysis model by learning an analysis model having a neural network structure constructed in advance using the feature data and present bias data regarding the users to be learned.

### TECHNICAL FIELD

One aspect of the present invention relates to a present bias analysis device, method, and program to be used to analyze a present bias of a user.

### BACKGROUND ART

Indicating human personality with quantitative numerical values is one of important elements for human understanding that is addressed in fields such as psychology and behavioral economics. In the behavioral economics, particular, an index called a present bias is attracting attention. The present bias refers to a cognitive bias that is over-reliant on endurance in the far future and impatient in the near future, that is, psychological characteristics of a human that, if a person balances a great benefit that can be obtained in the future and a small benefit that can be obtained immediately, the person selects the latter. A person having a strong present bias tends to be vulnerable to temptations at the moment and tends to postpone execution of a plan. As a result, it is known that a person having a strong present bias is less likely to receive a medical examination for health because he/she hates hardship at the moment and is more likely to have a lifestyle such as obesity or smoking (see, for example, Non Patent Literature 1).

It is therefore considered that by understanding strength of present biases of individuals, it is possible to understand tendency to postpone of the individuals and others and to effectively intervene in the individuals' behavior change.

Thus, in related art, a method of estimating a present bias by a question sheet has been proposed. This method is an estimation method using a “multiple-choice questionnaire”, and, for example, a plurality of questions regarding “Would you rather receive X yen today (option A) or Y yen seven days later (option B)?” is prepared such that Y yen is higher than X yen in each question, and respondents choose an option. In this event, a price in the option B is higher, and thus, a question designer has an “annual interest” as in a bank deposit. Focusing on a question in which selection is changed from the option A (receive today) to the option B (receive seven days later) among answer results, a discount rate of a respondent is assumed to be present between an annual interest of the question in which selection is changed and an annual interest of a question before the question, and thus, an average value of the two annual interests is adopted as a time discount rate. Similar questions are set in the farther future (e.g., 90 and 97 days later) to be answered, and the time discount rate is measured in a similar manner. In this event, the strength of the present bias can be measured by comparing the time discount rate between today and 7 days later and the time discount rate between 90 days and 97 days later (see, for example, Non Patent Literature 2).

### CITATION LIST

### Non Patent Literature

Non Patent Literature 1: Mischel, Walter et al. “Willpower over the life span: decomposing self-regulation.” Social cognitive and affective neuroscience, Vol. 6, No. 2 (2011): 252-6.

Non Patent Literature 2: Hardisty, David J. et al. “How to measure time preferences: An experimental comparison of three methods.” Judgment and Decision Making Vol. 8 (2013): 236-249.

### SUMMARY OF INVENTION

### Technical Problem

By the way, in the estimation method using the multiple-choice questionnaire, time discount rates of respondents are allocated based on annual interests determined by the question designer in advance. Thus, while answers do not tend to be dispersed, it is necessary to answer a plurality of questions. In addition, the order of questions is randomly changed according to the annual interest rate in order to avoid the responder from appropriately answering (for example, continuing to select the option B without considering), and thus, a plurality of places where the options A and B are switched are detected, and as a result, the number of responders treated as invalid answers increases. Furthermore, answers to a plurality of questions are required, and thus, burden on the responder is large, and the answer is performed at a medium-to long-term time interval, so that it is difficult to detect detailed change thereof.

The present invention has been made to solve the above problems, and an object of the present invention is to provide a technique capable of estimating a present bias based on information regarding daily life of a user without relying on a questionnaire.

### Solution to Problem

In order to solve the above problems, a first aspect of a present bias analysis device or method according to the present invention first acquires vital data, behavior data, and task data over a predetermined period of a plurality of users to be learned from a learning data storage unit, and performs predetermined preprocessing on each of the acquired vital data, behavior data, and task data. Next, feature data regarding the plurality of the users to be learned is generated by combining the preprocessed vital data, behavior data, and task data of the same users to be learned while aligning time-series positions. Then, a learned analysis model is generated by learning an analysis model having a neural network structure constructed in advance using the feature data and present bias data regarding the plurality of users to be learned.

According to the first aspect of the present invention, it is possible to create a present bias analysis model that enables estimation of a present bias of a user to be estimated by using vital data, behavior data, and task data acquired by a vital sensor or a scheduler in daily life of the user to be estimated without relying on a questionnaire survey.

According to a second aspect of the present invention, a vital data series, a behavior data series, and a task data series of a user to be estimated are acquired, and predetermined preprocessing is performed on each of the acquired vital data series, behavior data series, and task data series. Then, feature data regarding the user to be estimated is generated by combining the preprocessed vital data series, behavior data series, and task data series while aligning time-series positions, the generated feature data is input to a present bias analysis model having a neural network structure learned using feature data for learning and present bias data regarding a plurality of users to be learned, and present bias estimation data of the user to be estimated is obtained from the present bias analysis model.

According to the second aspect of the present invention, it is possible to estimate the present bias of the user to be estimated using the vital data series, the behavior data series, and the task data series acquired by the vital sensor or the scheduler in the daily life of the user to be estimated without relying on a questionnaire survey.

### Advantageous Effects of Invention

In other words, according to one aspect of the present invention, it is possible to provide a technique Capable of estimating a present bias based on information regarding a daily life of a user without relying on a questionnaire.

### BRIEF DESCRIPTION OF DRAWINGS

FIG. 1 is a view illustrating a configuration of a system including a present bias analysis device according to an embodiment of the present invention.

FIG. 2 is a block diagram illustrating an example of a hardware configuration of the present bias analysis device according to an embodiment of the present invention.

FIG. 3 is a block diagram illustrating an example of a software configuration of the present bias analysis device according to an embodiment of the present invention.

FIG. 4 is a flowchart indicating an example of overall processing procedure and processing content of present bias analysis model learning processing to be executed in a learning phase by a control unit of the present bias analysis device illustrated in FIG. 3.

FIG. 5 is a flowchart indicating an example of overall processing procedure and processing content of present bias analysis processing to be executed in an estimation phase by the control unit of the present bias analysis device illustrated in FIG. 3.

FIG. 6 is a flowchart indicating an example of processing procedure and processing content of preprocessing for vital data among the overall processing procedure indicated in FIG. 4.

FIG. 7 is a flowchart indicating an example of processing procedure and processing content of preprocessing for behavior data among the overall processing procedure indicated in FIG. 4.

FIG. 8 is a flowchart indicating an example of processing procedure and processing content of preprocessing for task data among the overall processing procedure indicated in FIG. 4.

FIG. 9 is a flowchart indicating an example of processing procedure and processing content of data combination processing among the overall processing procedure indicated in FIG. 4.

FIG. 10 is a flowchart indicating an example of processing procedure and processing content of time information extraction processing among the overall processing procedure indicated in FIG. 4.

FIG. 11 is a flowchart indicating an example of processing procedure and processing content of present bias analysis model learning processing among the overall processing procedure indicated in FIG. 4.

FIG. 12 is a flowchart indicating an example of processing procedure and processing content of present bias estimation processing among the overall processing procedure indicated in FIG. 5.

FIG. 13 is a view indicating an example of vital data stored in a vital data storage unit of the present bias analysis device illustrated in FIG. 3.

FIG. 14 is a view indicating an example of behavior data stored in a behavior data storage unit of the present bias analysis device illustrated in FIG. 3.

FIG. 15 is a view indicating an example of task data stored in a task data storage unit of the present bias analysis device illustrated in FIG. 3.

FIG. 16 is a view indicating an example of the preprocessed vital data.

FIG. 17 is a view indicating an example of the preprocessed behavior data.

FIG. 18 is a view indicating an example of the preprocessed task data.

FIG. 19 is a view indicating an example of feature data after the combination processing.

FIG. 20 is a view indicating an example of feature data with time information.

FIG. 21 is a view indicating an example of present bias data stored in a present bias data storage unit of the present bias analysis device illustrated in FIG. 3.

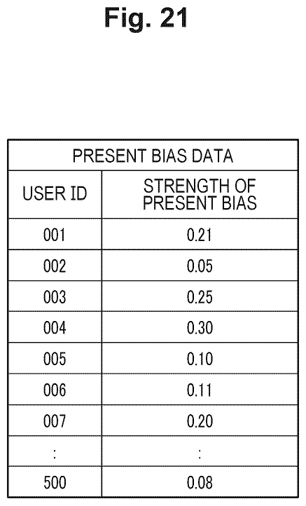

FIG. 22 is a view illustrating an example of a network structure of a present bias analysis model.

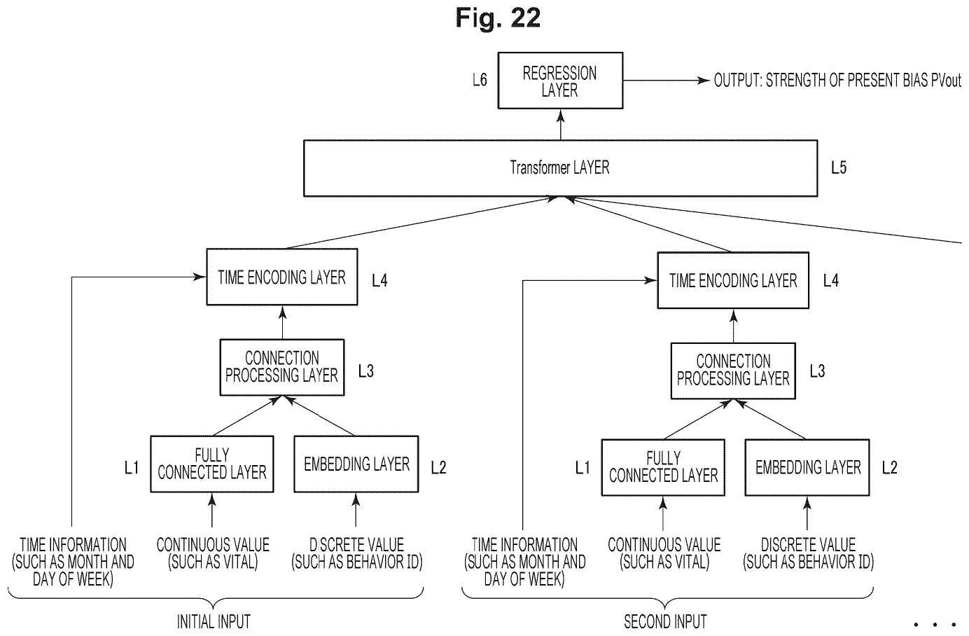

FIG. 23 is a view indicating an example of parameters of the present bias analysis model.

### DESCRIPTION OF EMBODIMENTS

Hereinafter, an embodiment according to the present invention will be described with reference to the drawings.

### One Embodiment

### Configuration Example

### (1) System

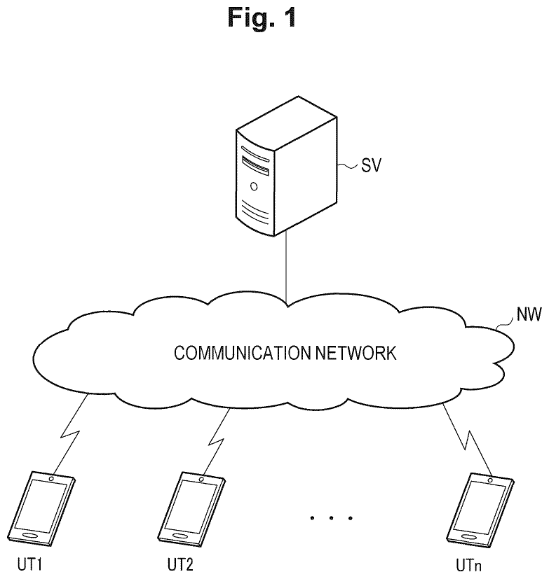

FIG. 1 is a view illustrating an example of a configuration of a system including a present bias analysis device according to an embodiment of the present invention.

The system according to an embodiment enables data transmission between a present bias analysis device SV and user terminals UT1 to UTn used by a plurality of users to be analyzed via a communication network NW.

As the user terminals UT1 to UTn, for example, general-purpose smartphones including input devices, display devices, and communication applications such as browsers or mailers are used.

The user terminals UT1 to UTn transmit a plurality of types of data necessary for estimating present biases of the users to the present bias analysis device SV by executing an application program installed in advance.

More specifically, the user terminals UT1 to UTn transmit vital data measured by a health management application, and behavior data and task data managed by a scheduler to the present bias analysis device SV. In addition, the user terminals UTI to UTn receive data indicating estimation results of the present biases transmitted from the present bias analysis device SV.

As the user terminals UT1 to UTn, wearable terminals, tablet terminals, personal computers, or the like, may be used in addition to smartphones.

The communication network NW includes, for example, a wide area network having the Internet as a core and an access network for accessing the wide area network. As the access network, for example, a public communication network using a wired or wireless network, a local area network (LAN) using a wired or wireless network, or a cable television (CATV) network is used, but the access network is not limited thereto.

### (2) Present Bias Analysis Device SV

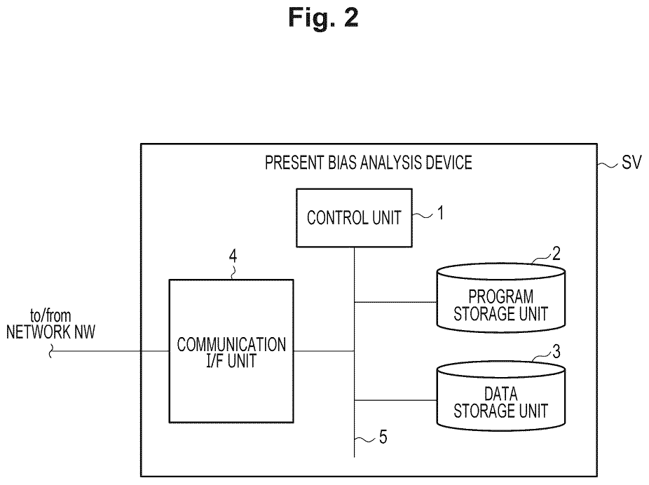

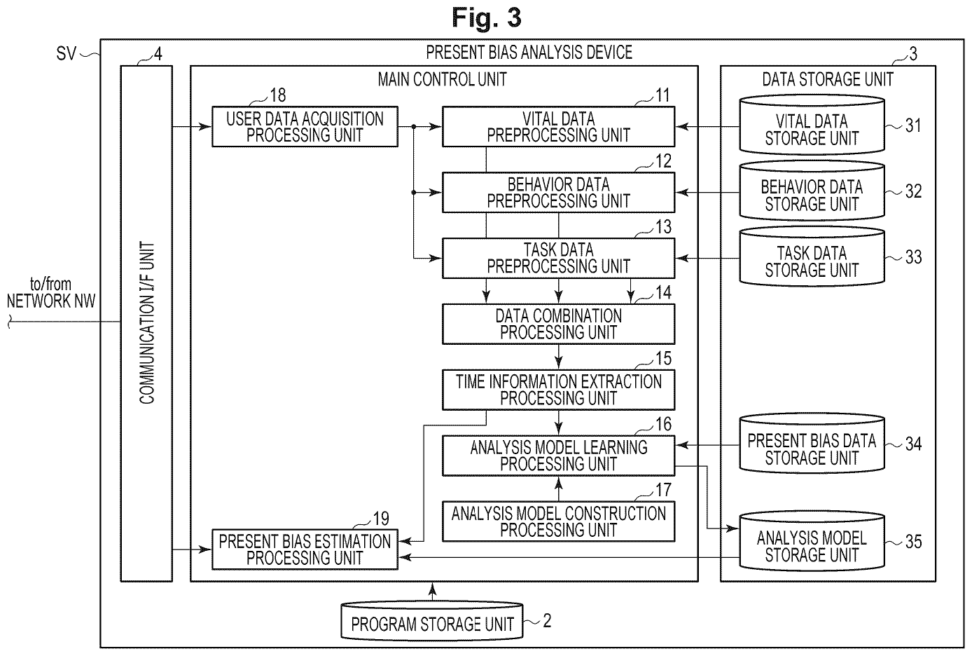

FIGS. 2 and 3 are block diagrams respectively illustrating an example of a hardware configuration and an example of a software configuration of the present bias analysis device SV according to an embodiment of the present invention.

The present bias analysis device SV includes, for example, a server computer or a personal computer arranged on the web or in a cloud. The present bias analysis device SV includes a control unit 1 using a hardware processor such as a central processing unit (CPU), and a storage unit including a program storage unit 2 and a data storage unit 3 and a communication interface (hereinafter, the interface is referred to as an I/F) unit 4 are connected to the control unit 1 via a bus 5.

The communication I/F unit 4 performs access control and data transmission/reception with respect to the communication network NW under control of the control unit 1. More specifically, the communication I/F unit 4 receives the vital data, the behavior data, and the task data of the users transmitted from the user terminals UT1 to UTn, and transmits data indicating estimation results of the present biases of the users obtained by the control unit 1 to the user terminals UT1 to UTn.

The program storage unit 2 is configured, for example, by combining a non-volatile memory such as a hard disk drive (HDD) or a solid state drive (SSD) that can be written to and read from at any time and a non-volatile memory such as a read only memory (ROM) serving as storage media, and stores various programs necessary for executing various kinds of control processing according to one embodiment of the present invention in addition to middleware such as an operating system (OS).

The data storage unit 3 is configured by a combination of, for example, a non-volatile memory capable of writing and reading as needed, such as an HDD or an SSD, and a volatile memory such as a random access memory (RAM) as storage media, and includes a vital data storage unit 31, a behavior data storage unit 32, a task data storage unit 33, a present bias data storage unit 34, and an analysis model storage unit 35 as the storage units according to an embodiment in a storage area of the data storage unit 3.

The vital data storage unit 31 stores a plurality of pieces of vital data measured in a certain period for a plurality of users to be used for learning the present bias analysis model. Similarly, the behavior data storage unit 32 and the task data storage unit 33 respectively store data representing behavior and tasks executed in a certain period of the plurality of users to be used for learning of the present bias analysis model.

The present bias data storage unit 34 stores known data of the present biases of the plurality of users to be learned as training data to be used upon learning of the present bias analysis model.

The analysis model storage unit 35 is used to store data representing the learned present bias analysis model.

The control unit 1 includes a vital data preprocessing unit 11, a behavior data preprocessing unit 12, a task data preprocessing unit 13, a data combination processing unit 14, a time information extraction processing unit 15, an analysis model learning processing unit 16, an analysis model construction processing unit 17, a user data acquisition processing unit 18, and a present bias estimation processing unit 19 as processing functions for executing one embodiment of the present invention.

These processing units 11 to 19 are all implemented by causing a hardware processor of the control unit 1 to execute application programs stored in the program storage unit 2. Some or all of the processing units 11 to 19 may be implemented using hardware such as a large scale integration (LSI) circuit or an application specific integrated circuit (ASIC).

The vital data preprocessing unit 11 reads vital data to be learned from the vital data storage unit 31 in a learning phase and receives a vital data series of the users to be estimated transmitted from the user terminals UT1 to UTn in an estimation phase. Then, the vital data preprocessing unit 11 calculates a summary statistic for each time section having a preset time length for the acquired vital data and outputs data including the calculation result as the preprocessed vital data.

The behavior data preprocessing unit 12 reads behavior data to be learned from the behavior data storage unit 32 in the learning phase and receives the behavior data of the users to be estimated transmitted from the user terminals UT1 to UTn in the estimation phase. Then, the behavior data preprocessing unit 12 performs data aggregation by deleting, for example, the same data or a small number of data from the acquired behavior data and assigns a behavior ID indicating a type of the behavior and time information to the aggregated behavior. Then, the generated data is output as the preprocessed behavior data.

The task data preprocessing unit 13 reads task data to be learned from the task data storage unit 33 in the learning phase and receives the task data of the users to be estimated transmitted from the user terminals UT1 to UTn in the estimation phase. Then, the task data preprocessing unit 13 calculates, for example, a target achievement rate and a target progression rate for the received task data, aggregates the calculation results for each time section, and outputs data obtained by the calculation as the preprocessed task data.

The data combination processing unit 14 combines the preprocessed vital data, behavior data, and task data with the same time section for each user, thereby generating combined feature data for each user.

The time information extraction processing unit 15 extracts time information represented by “month”, “day of week”, “date”, and “time” for each time section from the combined feature data of each of the users and adds the extracted time information to the combined feature data, thereby generating feature data with time information.

The analysis model construction processing unit 17 constructs a present bias analysis model that handles the feature data with time information using a network structure of a deep neural network (DNN).

In the learning phase, the analysis model learning processing unit 16 learns each parameter of the present bias analysis model constructed by the analysis model construction processing unit 17 by using the feature data with time information of each user to be learned and present bias known data of the users to be learned stored in the present bias data storage unit 34. Then, the learned present bias analysis model is stored in the analysis model storage unit 35.

In the estimation phase, the user data acquisition processing unit 18 acquires the vital data series, the behavior data series, and the task data series of the users to be estimated from the user terminals UT1 to UTn used by the users to be estimated via the communication I/F unit 4.

In the estimation phase, the present bias estimation processing unit 19 inputs the feature data with time information of the users to be estimated generated by the time information extraction processing unit 15 to the learned present bias analysis model stored in the analysis model storage unit 35. Then, the present bias estimation data output from the learned present bias analysis model is transmitted from the communication I/F unit 4 to, for example, the user terminals of the users to be estimated.

### Operation Example

Next, an operation example of the present bias analysis device SV configured as described above will be described.

### (1) Learning Phase

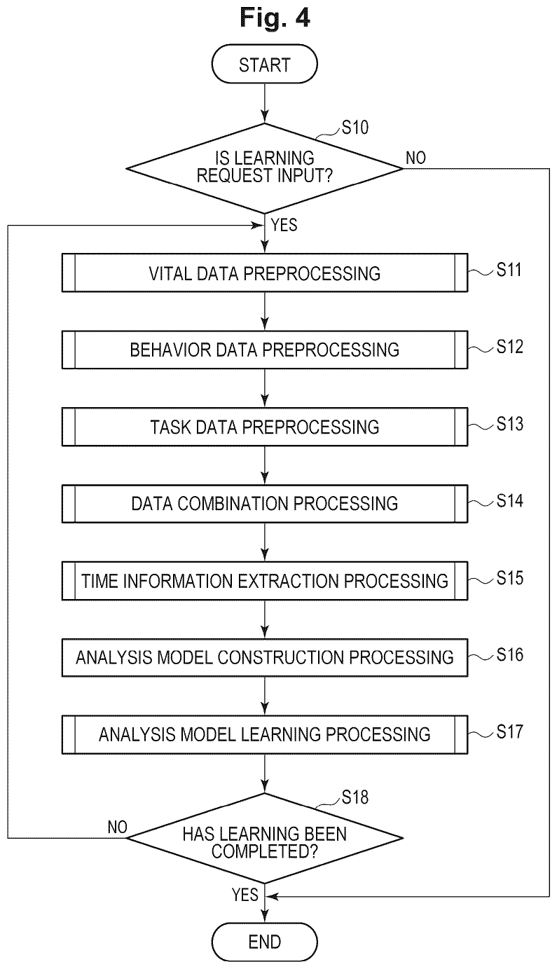

FIG. 4 is a flowchart indicating an example of processing procedure and processing content of present bias analysis model learning processing to be executed by the control unit 1 of the present bias analysis device SV in the learning phase.

Note that the description will be given on the assumption that the vital data, the behavior data, and the task data of a plurality of users to be learned are stored in advance in the vital data storage unit 31, the behavior data storage unit 32, and the task data storage unit 33.

In addition, it is assumed that known data of present biases of the plurality of users to be learned is also stored in the present bias data storage unit 34 in advance.

In this state, for example, if a system administrator inputs a learning request from an administrator terminal (not illustrated), and the control unit 1 of the present bias analysis device SV detects the learning request in step $10, the control unit 1 of the present bias analysis device SV sets the learning phase and executes the present bias analysis model learning processing as follows.

### (1-1) Preprocessing of Vital Data

First, in step S11, the control unit 1 of the present bias analysis device SV preprocesses the vital data as follows under control of the vital data preprocessing unit 11.

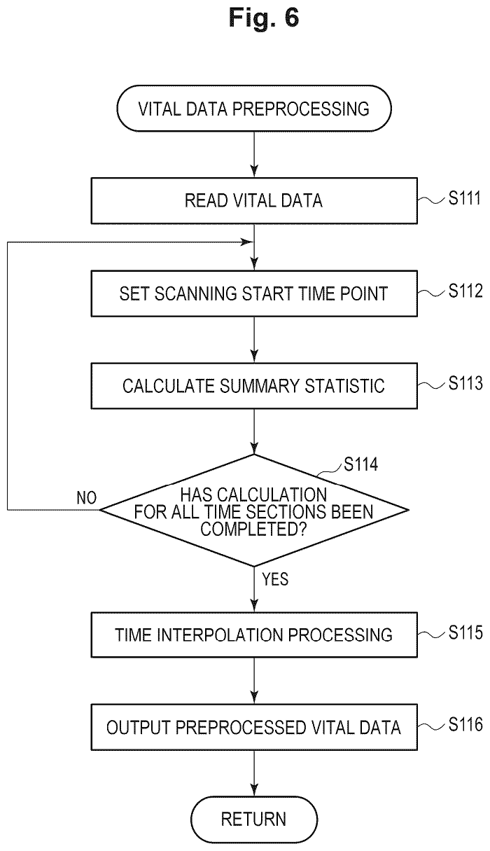

FIG. 6 is a flowchart indicating an example of processing procedure and processing content of the vital data preprocessing to be executed by the vital data preprocessing unit 11.

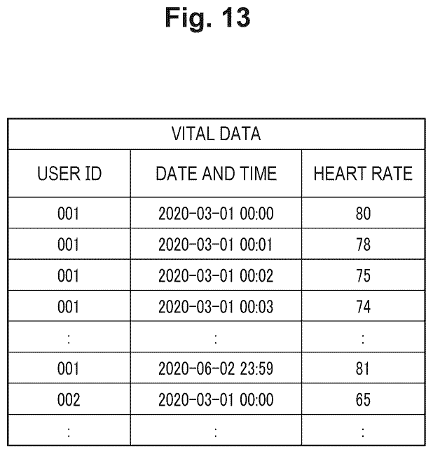

In other words, the vital data preprocessing unit 11 first reads the vital data from the vital data storage unit 31 in step S111. The vital data is data in which a measured heart rate and measurement date and time thereof are associated with identification information of the user (hereinafter, referred to as a user ID) for each entry indicated as each row in FIG. 13, for example.

The vital data preprocessing unit 11 sets a start time point of the read vital data for each time section having a fixed time length set in advance in step S112 and calculates a summary statistic of the heart rate measured in the time section in step S113. As the summary statistic, for example, an average, a standard deviation, a maximum value, and a minimum value of the heart rate are calculated.

The vital data preprocessing unit 11 determines whether or not calculation for all the time sections of the vital data has been completed in step S114 every time the processing of calculating the summary statistic for one time section is completed. Then, if an uncalculated time section remains, the processing returns to step S112 to set the next time section, and the calculation processing of the summary statistic in step S113 is executed.

Thereafter, the calculation processing of the summary statistic for each uncalculated time section is repeated.

On the other hand, if the calculation for all the time sections is completed, the processing proceeds to step S115, and the vital data preprocessing unit 11 performs processing of interpolating data between the time sections. Then, the vital data including the interpolated data is output to the data combination processing unit 14 in step S116 as the preprocessed vital data VD1.

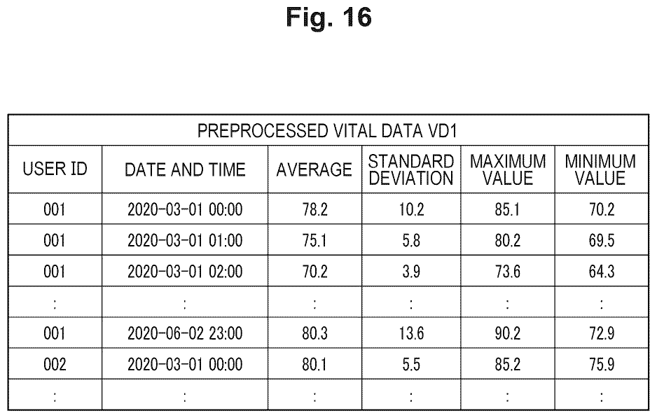

FIG. 16 indicates an example of the preprocessed vital data VD1.

### (1-2) Preprocessing of Behavior Data

Next, in step $12, the control unit 1 of the present bias analysis device SV preprocesses the behavior data as follows under control of the behavior data preprocessing unit 12.

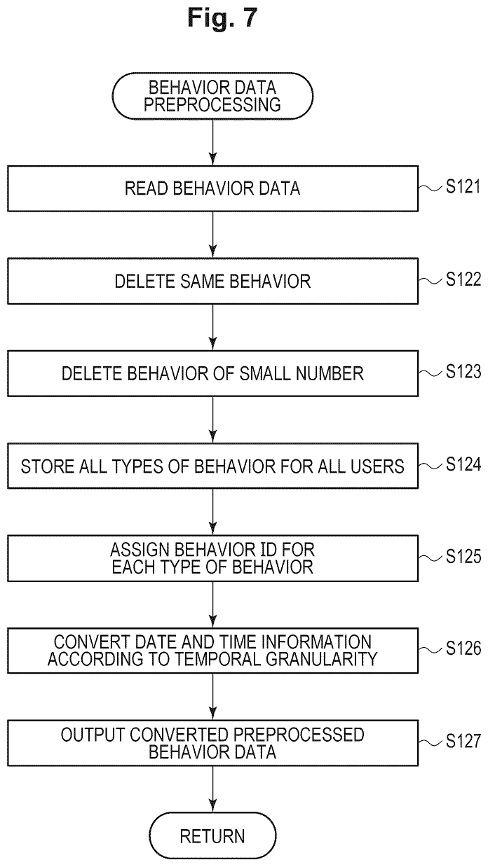

FIG. 7 is a flowchart indicating an example of processing procedure and processing content of behavior data preprocessing to be executed by the behavior data preprocessing unit 12.

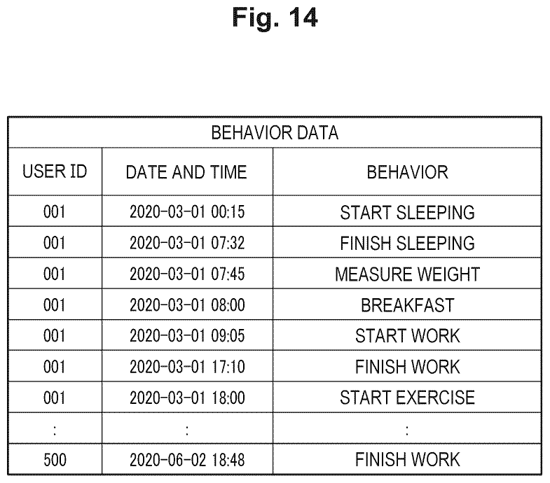

In other words, the behavior data preprocessing unit 12 first reads the behavior data of each user to be learned from the behavior data storage unit 32 in step S121. The behavior data is data in which, for example, content of the behavior and execution date and time thereof are associated with the user ID for each entry indicated as each row in FIG. 14.

The behavior data preprocessing unit 12 first sequentially compares respective entries in step S122 for each user with respect to the respective pieces of the read behavior data to be learned. Then, for example, if the same behavior continuously appears within a short period set in advance, other entries are deleted while one entry is left. For example, in a case where behavior of “start exercise” of a certain user appears a predetermined number of times or more in a period of a predetermined time width, only first appearance “start exercise” is left, and the Other same “start exercise” is regarded as being erroneously registered and deleted. It is only necessary to arbitrarily set the length of the time width by the system administrator.

Subsequently, in step S123, the behavior data preprocessing unit 12 compares the behavior of each entry and deletes the entry of the behavior for which the number of observations is less than a certain number. For example, the number of appearances is counted for each type of behavior, and behavior for which the number of appearances is less than a predetermined number set by the system administrator is deleted. By performing each kind of the above-described deletion processing, entry aggregation can be performed for the behavior data.

The behavior data preprocessing unit 12 executes aggregation of entries in steps S122 and S123 described above for entries of all users. Then, the entries of the behavior of all the users remaining as a result of the aggregation of the entries are temporarily stored, and behavior IDs for identifying types of the stored behavior are assigned to the stored behavior in step S125.

Finally, in step $126, the behavior data preprocessing unit 12 converts the date and time included in each entry of the behavior data into time information according to the granularity of the time section defined in the preprocessing of the vital data. Then, the behavior data converted from the time information is output to the data combination processing unit 14 in step S127 as the preprocessed behavior data AD1.

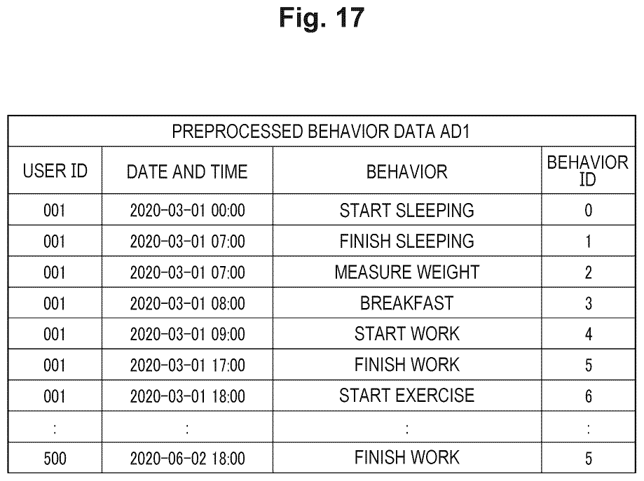

FIG. 17 indicates an example of the preprocessed behavior data AD1.

### (1-3) Preprocessing of Task Data

Next, in step S13, the control unit 1 of the present bias analysis device SV performs preprocessing of the task data as follows under control of the task data preprocessing unit 13.

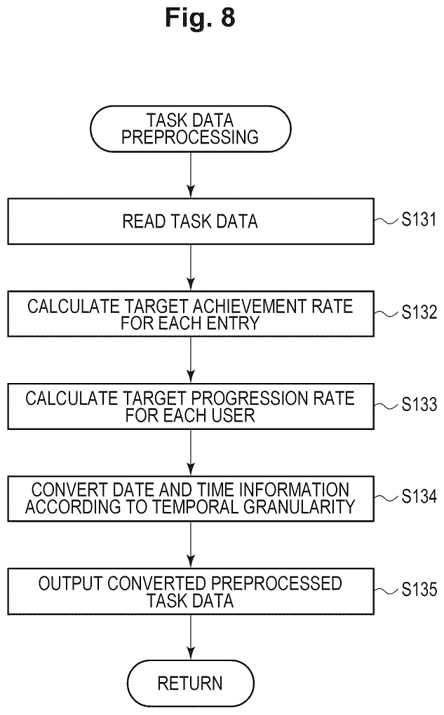

FIG. 8 is a flowchart indicating an example of processing procedure and processing content of task data preprocessing to be executed by the task data preprocessing unit 13.

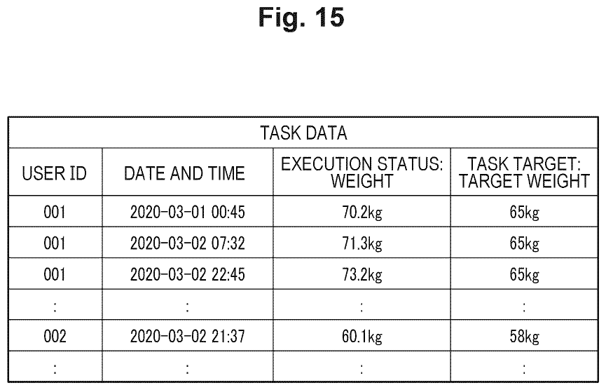

In other words, the task data preprocessing unit 13 first reads the task data from the task data storage unit 33 in step S131. The task data is data in which content of the task and execution date and time of the task are associated with the user ID for each entry indicated as each row in FIG. 15, for example. In this example, the content of the task relates to dieting, and is represented by a current weight representing an execution status and a target weight.

The task data preprocessing unit 13 first calculates a target achievement rate for each entry in step S132 with respect to the read task data. Then, in step S133, a target progression rate for each user is calculated. Next, in step $134, the task data preprocessing unit 13 converts the date and time included in each entry of the task data into time information according to the granularity of the time section previously defined in the preprocessing of the vital data. Then, the task data converted from the time information is output to the data combination processing unit 14 in step $135 as preprocessed task data TD1.

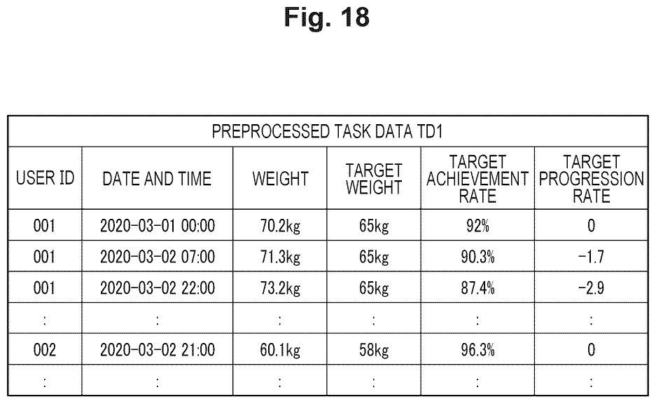

FIG. 18 indicates an example of the preprocessed task data TD1.

### (1-4) Data Combination Processing

Next, in step S14, the control unit 1 of the present bias analysis device SV performs data combination processing as follows under control of the data combination processing unit 14.

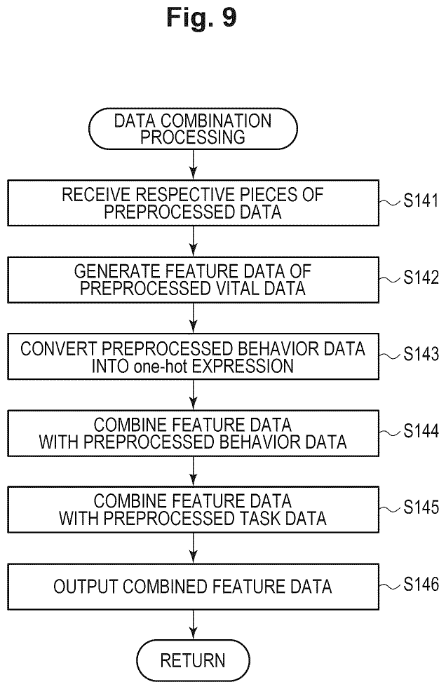

FIG. 9 is a flowchart indicating an example of processing procedure and processing content of the data combination processing to be executed by the data combination processing unit 14.

In other words, first, in step S141, the data combination processing unit 14 receives the preprocessed vital data VD1, behavior data AD1, and task data TD1 from the vital data preprocessing unit 11, the behavior data preprocessing unit 12, and the task data preprocessing unit 13, respectively. Then, in step S142, the data combination processing unit 14 generates a copy of the preprocessed vital data VD1 and sets the copy as feature data VD2 of the vital data.

Next, in step S143, the data combination processing unit 14 converts the behavior ID of the preprocessed behavior data AD1 into one-hot expression. For example, a vector having dimensions that are the same as the number of types of behavior is prepared, and only a dimension of a numerical value representing the behavior ID is converted into “1”, and the other dimensions are converted into “0”. Then, in step $144, the data combination processing unit 14 combines the preprocessed behavior data AD2 in which expression of the behavior ID has been converted with the feature data of the vital data for the same user while aligning the time section based on the user ID and the time information.

Furthermore, in step S145, the data combination processing unit 14 combines the preprocessed task data TD2 with the feature data of the vital data for the same user while aligning the time interval based on the user ID and the time information. Then, the data combination processing unit 14 outputs the combined feature data to the time information extraction processing unit 15 in step S146.

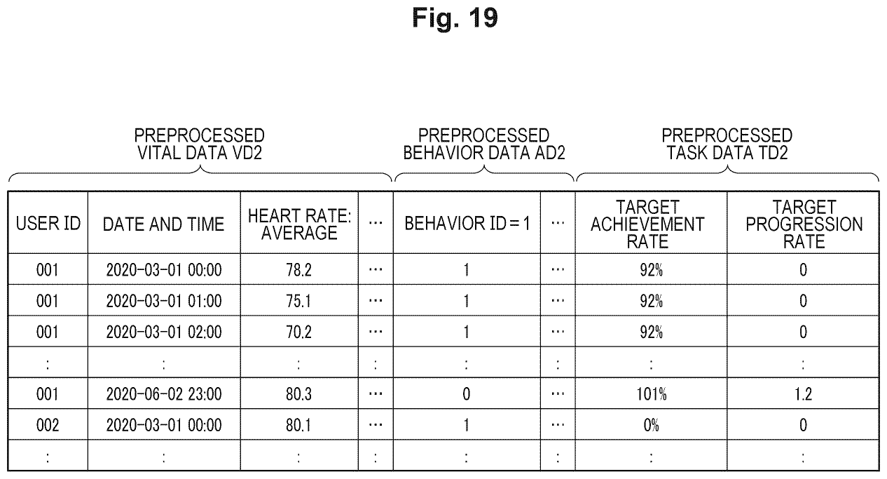

FIG. 19 indicates an example of the combined feature data, in which VD2 represents the preprocessed vital data, AD2 represents the preprocessed behavior data, and TD2 represents the preprocessed task data.

### (1-5) Extraction of Time Information

Next, in step $15, the control unit 1 of the present bias analysis device SV performs time information extraction processing as follows under control of the time information extraction processing unit 15.

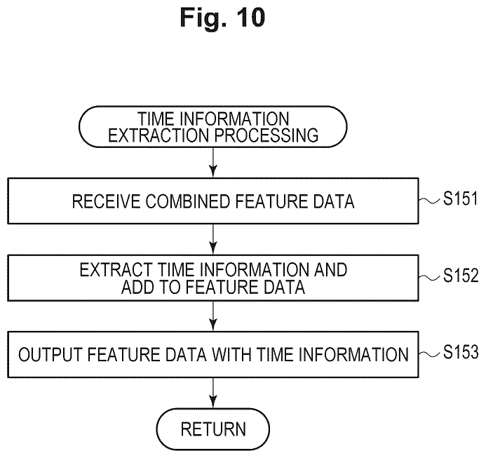

FIG. 10 is a flowchart indicating an example of processing procedure and processing content of the time information extraction processing to be executed by the time information extraction processing unit 15.

In other words, the time information extraction processing unit 15 first receives the combined feature data from the data combination processing unit 14 in step $151. Then, in step S152, the time information extraction processing unit 15 extracts “month”, “day of week”, “date”, and “time” constituting time information for each entry of the combined feature data based on the date and time included in the entry, and adds each element of the extracted time information to the entry of the combined feature data.

Finally, the time information extraction processing unit 15 outputs the combined feature data after the time information is added (hereinafter referred to as feature data with time information), to the analysis model learning processing unit 16 in step $153.

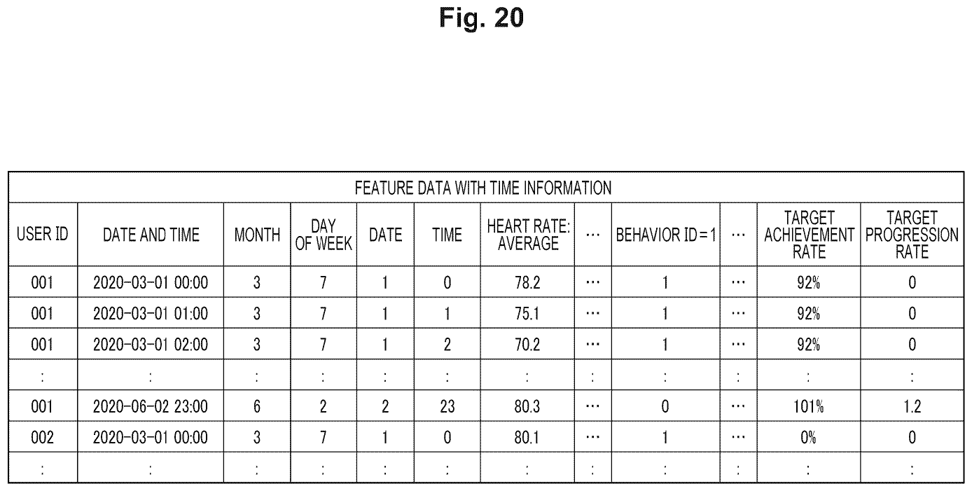

FIG. 20 indicates an example of the feature data with time information output from the time information extraction processing unit 15.

### (1-6) Construction of Present Bias Analysis Model

Next, in step $16, the control unit 1 of the present bias analysis device SV constructs a present bias analysis model by the analysis model construction processing unit 17. The present bias analysis model is configured using, for example, a DNN, and uses feature data for each user as an input and outputs an estimated value of the strength of the present bias of the user.

FIG. 17 illustrates an example of a network structure of the present bias analysis model constructed by the analysis model construction processing unit 17. In Other words, the present bias analysis model has a configuration in which a fully connected layer L1 and an embedding layer L2 are arranged as input layers, and a connection processing layer L3, a time encoding layer L4, a transformer layer L5, and a regression layer L6 are arranged in this order.

The fully connected layer L1 extracts an abstract feature from continuous values of the input feature data.

More specifically, an embedding layer having the number of data strings of the continuous values as an input is prepared, converted into a feature vector having a specific number of dimensions, and output.

The embedding layer L2 extracts an abstract feature from a category value in the input feature data. For example, an embedding layer having the number of dimensions of the number of types of behavior as an input is prepared, converted into a feature vector having a specific number of dimensions, and output.

The connection processing layer L3 combines the two feature vectors output from the fully connected layer L1 and the embedding layer L2. For example, two feature vectors are connected in a lateral direction, and the connected feature vector is output.

The time encoding layer L4 assigns time information to the feature vector. For example, after time information in the feature data with time information is input to the fully connected layer, nonlinear conversion is performed using an activation function (for example, a Sigmoid function, a ReLU function, or the like), and the converted feature vector is output.

The transformer layer L5 further abstracts the abstracted feature vector as series data. Specifically, the series data is sequentially received and repeatedly subjected to nonlinear conversion.

The regression layer L6 converts the feature vector converted by the transformer layer into a scalar value corresponding to the strength of the present bias.

### (1-7) Learning of Present Bias Analysis Model

Next, in step S17, under the control of the analysis model learning processing unit 16, the control unit 1 of the present bias analysis device SV executes processing of learning the present bias analysis model constructed by the analysis model construction processing unit 17 as follows.

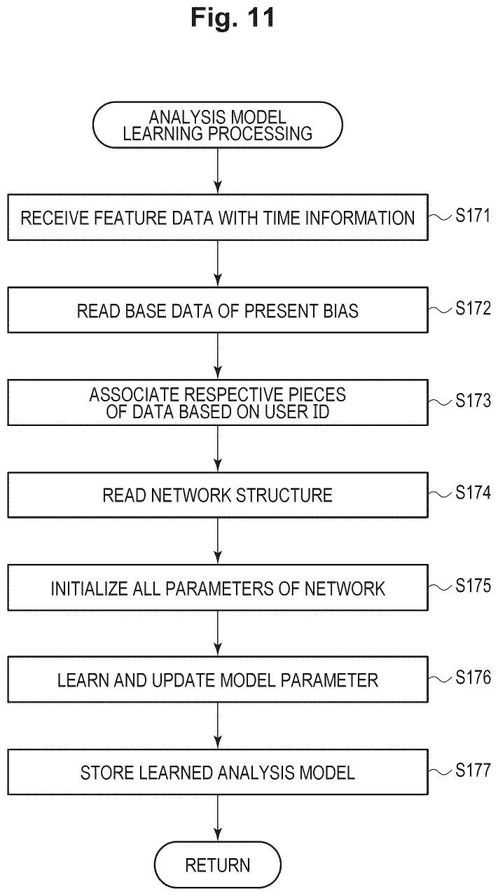

FIG. 11 is a flowchart indicating an example of processing procedure and processing content of the present bias analysis model learning processing to be executed by the analysis model learning processing unit 16.

In other words, the analysis model learning processing unit 16 first receives the feature data with time information to be learned from the time information extraction processing unit 15 in step S171. In addition, the analysis model learning processing unit 16 reads the known data of the present bias of each user to be learned from the present bias data storage unit 34 in step S172. Then, in step S173, the analysis model learning processing unit 16 associates each entry of the feature data with time information with the known data of the present bias based on the user ID.

Next, in step S174, the analysis model learning processing unit 16 receives a network structure of the present bias analysis model from the analysis model construction processing unit 17. Then, in step S175, the analysis model learning processing unit 16 initializes the parameters of the layers L1 to L6 of the received network structure. Specifically, each parameter is initialized using a normal distribution random number having an average “0” and a standard deviation “1”.

Next, in step S176, the analysis model learning processing unit 16 learns each parameter of the network Structure using the input feature data with time information and the known data of the present bias for each user ID. Specifically, each time the entry of the feature data with time information is input, each parameter of the network structure is learned and updated using the preprocessed vital data VD2, behavior data AD2, and task data TD2 included in the entry, and the known data of the present bias of the corresponding user to be learned.

Then, if the learning/update processing using all the entries of the input feature data with time information is completed, the analysis model learning processing unit 16 stores the network structure for which the learning/update processing has been completed and the parameters thereof in the analysis model storage unit 35 as the present bias analysis model MD learned in step S177.

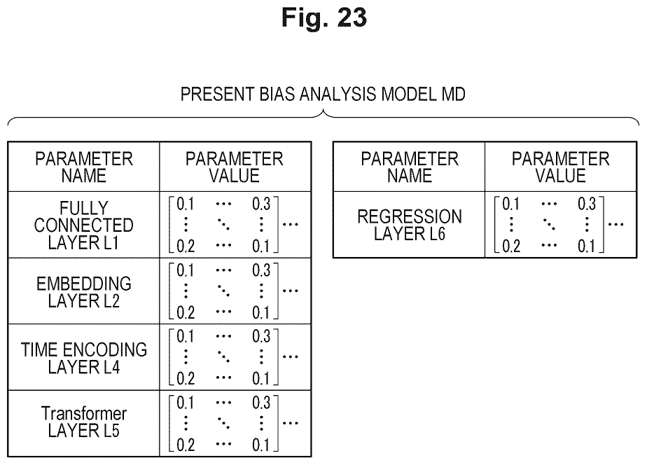

FIG. 23 indicates an example of the learned present bias analysis model MD stored in the analysis model storage unit 35.

### (2) Estimation Phase

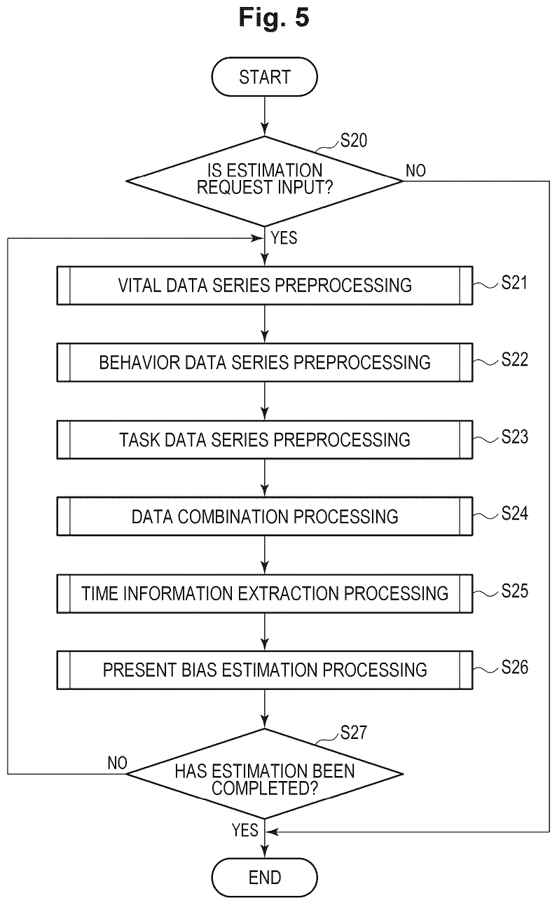

FIG. 5 is a flowchart indicating an example of processing procedure and processing content of present bias estimation processing to be executed by the control unit 1 of the present bias analysis device SV in the estimation phase.

For example, it is assumed that the user to be estimated or the system administrator inputs an estimation request of the present bias of the user in the user terminal UT1 or the administrator terminal. If the control unit 1 of the present bias analysis device SV detects the input of the estimation request in step S10, the control unit 1 sets the estimation phase, and thereafter executes estimation processing of the present bias of the user to be estimated as follows.

### (2-1) Acquisition of User Data

If the estimation phase is set, first, under control of the user data acquisition processing unit 18, the control unit 1 of the present bias analysis device SV acquires, for example, the vital data series, the behavior data series, and the task data series of the user in the latest predetermined period, which are transmitted from the user terminal UT1 used by the user to be estimated, via the communication I/F unit 4.

### (2-2) Preprocessing of Vital Data Series

First, in step S21, the control unit 1 of the present bias analysis device SV receives the vital data series of the user to be estimated from the user data acquisition processing unit 18 under control of the vital data preprocessing unit 11. Then, for the received vital data series, similarly to the case of the learning phase, a Summary statistic is calculated for each predetermined time section according to the processing procedure and the processing content indicated in FIG. 6, and a preprocessed vital data series including the calculated summary statistic is generated.

### (2-3) Preprocessing of Behavior Data Series

Next, in step S22, the control unit 1 of the present bias analysis device SV receives the behavior data series of the user to be estimated from the user data acquisition processing unit 18 under control of the behavior data preprocessing unit 12. Then, for the received behavior data series, entries of the behavior of the user to be estimated are aggregated by deleting entries of the Overlapping behavior and entries of behavior of a small number according to the processing procedure and the processing content indicated in FIG. 7, similarly to the case of the learning phase, thereby generating the preprocessed behavior data series.

### (2-4) Preprocessing of Task Data

Next, in step S23, the control unit 1 of the present bias analysis device SV receives the task data series of the user to be estimated from the user data acquisition processing unit 18 under control of the task data preprocessing unit 13. Then, for the received task data series, similarly to the case of the learning phase, a target achievement rate is calculated for each entry according to the processing procedure and the processing content indicated in FIG. 8, and a target progression rate for each user is calculated, thereby generating the preprocessed task data series.

### (2-5) Data Combination Processing

Next, in step $24, the control unit 1 of the present bias analysis device SV receives the preprocessed vital data series, behavior data series, and task data series under control of the data combination processing unit 14.

Then, similarly to the case of the learning phase, the preprocessed vital data series, behavior data series, and task data series are combined while time positions are aligned according to the processing procedure and the processing content indicated in FIG. 9, and the combined data is output as the feature data of the user to be estimated.

### (2-6) Extraction of Time Information

Next, in step S25, under control of the time information extraction processing unit 15, similarly to the case of the learning phase, the control unit 1 of the present bias analysis device SV extracts time information from the combined feature data of the user to be estimated according to the processing procedure and the processing content indicated in FIG. 10, and adds the extracted time information to the combined feature data, thereby generating feature data with time information.

### (2-7) Estimation of Present Bias

Next, in step S26, the control unit 1 of the present bias analysis device SV executes processing of estimating the present bias of the user to be estimated under control of the present bias estimation processing unit 19 as follows.

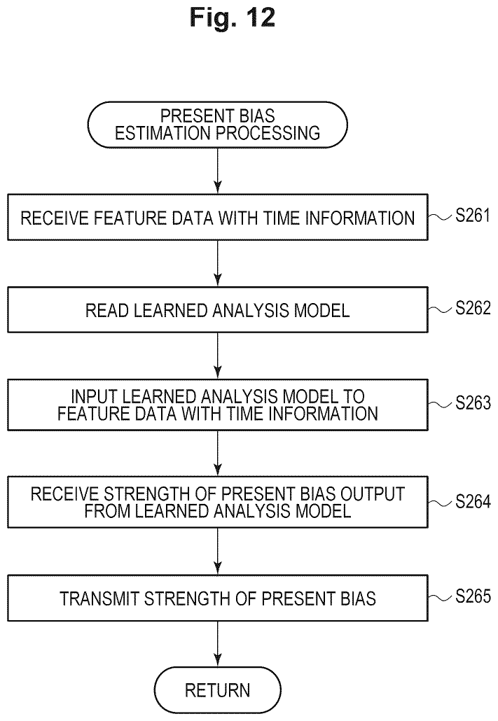

FIG. 12 is a flowchart indicating an example of processing procedure and processing content of present bias estimation processing to be executed by the present bias estimation processing unit 19.

In other words, the present bias estimation processing unit 19 first receives the feature data with time information of the user to be estimated from the time information extraction processing unit 15 in step S261.

Then, the present bias estimation processing unit 19 reads the learned present bias analysis model MD from the analysis model storage unit 35 in step S262, and inputs the feature data with time information of the user to be estimated to the read learned present bias analysis model MD in step S263.

As a result, the learned present bias analysis model MD outputs estimation data indicating the strength of the present bias of the user to be estimated corresponding to the feature data with time information. In step S264, the present bias estimation processing unit 19 receives the estimation data of the present bias output from the learned present bias analysis model and transmits the received estimation data from the communication I/F unit 4 to the user terminal UT1 that is a request source or the administrator terminal in step S265.

(2-8) End Determination of Estimation Processing In step S27, the control unit 1 of the present bias analysis device SV determines whether or not the present bias strength estimation processing for all the requested users to be estimated has been completed. Then, if the user to be estimated for which the estimation processing has not been performed remains, the processing returns to step S21, and a series of processing for estimating the present bias of the user to be estimated is repeatedly executed in steps S21 to S27.

On the other hand, if the present bias strength estimation processing is completed for all the users to be estimated, the control unit 1 of the present bias analysis device SV returns to a standby state.

### Operations and Effects

As described above, in one embodiment, first, in the learning phase, the present bias analysis model configured by the DNN is learned by using the feature data generated by performing predetermined preprocessing on each of the vital data, the behavior data, and the task data of the plurality of users collected and accumulated in advance, and then combining the data while aligning time positions for each user, and known data of the present bias of each user, and the learned present bias analysis model MD is stored. Then, in the estimation phase, a vital data series, a behavior data series, and a task data series of the user to be estimated are acquired, and after the predetermined preprocessing is performed on each of the acquired data series, the feature data of the user to be estimated is generated by combining the data series while aligning time positions, and the generated feature data is input to the learned present bias analysis model MD, thereby the present bias of the user to be estimated is output.

Thus, according to the embodiment, the present bias of the user to be estimated can be estimated by using the vital data, the behavior data, and the task data acquired by the vital sensor and the scheduler in the daily life of the user to be estimated without relying on a questionnaire survey.

In particular, by processing the vital data, the behavior data, and the task data of the user to be estimated as the series data by the analysis model using the DNN, it is possible to extract features in consideration of the context of the behavior and the behavior serving as a background of achievement and failure of the task, so that it is possible to estimate the present bias of the user with high accuracy.

In addition, setting the time section for the vital data enables calculation of the summary statistic, which enables feature extraction robust against abnormal values and noise.

Further, extracting time information for each of the vital data, the behavior data and the task data enables estimation in which periodicity on a monthly basis, on a weekly basis, on a basis of day of week, and on an hourly basis is taken into account.

### Other Embodiments

(1) In one embodiment, a case has been described as an example where the functions of the present bias analysis device are provided in one server computer arranged on the web or in a cloud. However, the present invention is not limited thereto, and the functions of the present bias analysis device may be distributed and arranged in, for example, a plurality of server computers capable of mutual communication via a communication network, or may be provided in, for example, a user terminal or an administrator terminal. Furthermore, in this case, a program for implementing the functions of the present bias analysis device may be prepared on the server computer, and the user terminal or the administrator terminal may download and use the program as necessary.
(2) In one embodiment, a case has been described as an example where the storage units 31 to 33 that store the vital data, the behavior data, and the task data for learning, and the storage unit 34 that stores the present bias data of the users to be learned are provided in the present bias analysis device SV. However, the present invention is not limited thereto, and each of the storage units 31 to 34 may be provided in, for example, a data accumulation server on a cloud, and when the present bias analysis device learns the analysis model, the vital data, the behavior data, and the task data for learning may be downloaded from the data accumulation server. Similarly, the analysis model storage unit 35 may be provided in a data accumulation server, or the like, and the present bias analysis device may download the present bias analysis model from the data accumulation server upon estimation of the present bias of the user to be estimated.
(3) In the embodiment, a case has been described as an example where the present bias analysis model is configured using a DNN. However, the present bias analysis model may be configured by using other neural networks such as convolution neural network (CNN), recurrent neural network (RNN), and generative adversarial network (GAN).
(4) In addition, the functional configuration of the present bias analysis device, the processing procedure and processing content for executing each function, a type of vital data, a type and content of behavior and tasks, and the like, can be variously modified and implemented without departing from the scope of the present invention.

Although the embodiment of the present invention has been described in detail above, the above description is merely illustrative of the present invention in every respect. It goes without saying that various modifications and variations can be made without departing from the scope of the present invention. In other words, a specific configuration according to the embodiment may be appropriately employed in implementing the present invention.

In short, the present invention is not limited to the above-described embodiment without any change and can be embodied by modifying the configurational elements within a range without departing from the gist of the present invention at the implementation stage. Further, various inventions can be formed by appropriate Combinations of the plurality of components disclosed in the above embodiment. For example, some components of all the components indicated in the embodiment may be omitted. Further, components in different embodiments may be appropriately combined.

### REFERENCE SIGNS LIST

SV Present bias analysis device
UT1 to UTn User terminal
NW Communication network
1 Control unit
2 Program storage unit
3 Data storage unit
4 Communication I/F unit
5 Bus
11 Vital data preprocessing unit
12 Behavior data preprocessing unit
13 Task data preprocessing unit
14 Data combination processing unit
15 Time information extraction processing unit
16 Analysis model learning processing unit
17 Analysis model construction processing unit
18 User data acquisition processing unit
19 Present bias estimation processing unit
31 Vital data storage unit
32 Behavior data storage unit
33 Task data storage unit
34 Present bias data storage unit
35 Analysis model storage unit

1. A present bias analysis device comprising processing circuitry configured to:
acquire vital data, behavior data, and task data over a predetermined period of a plurality of users to be learned from a learning data storage and perform predetermined preprocessing on each of the acquired vital data, the acquired behavior data, and the acquired task data;
generate feature data regarding a plurality of the users to be learned by combining the preprocessed vital data, the preprocessed behavior data, and the preprocessed task data of the same users to be learned while aligning time-series positions; and
generate a learned analysis model by learning an analysis model having a neural network structure constructed in advance using the feature data and present bias data regarding a plurality of the users to be learned.

2. The present bias analysis device according to claim 1, wherein the processing circuitry is further configured to:
extract, from the feature data, time information represented in a plurality of units based on information indicating the time-series positions of the vital data, the behavior data, and the task data and add the extracted time information to the feature data,
learn the analysis model by reflecting temporal periodicity of the feature data using the feature data to which the time information is added and the present bias data.

3. The present bias analysis device according to claim 1, wherein the processing circuitry is configured to perform at least one of data conversion processing, aggregation processing, or interpolation processing on each of the acquired vital data, the acquired behavior data, and the acquired task data according to characteristics of data to be processed corresponding to the acquired vital data, the acquired behavior data, or the acquired task data.

4. A present bias analysis method comprising:
acquiring vital data, behavior data, and task data over a predetermined period of a plurality of users to be learned from a learning data storage [[unit]] and performing predetermined preprocessing on each of the acquired vital data, the acquired behavior data, and the acquired task data;
generating feature data regarding a plurality of the users to be learned by combining the preprocessed vital data, the preprocessed behavior data, and the preprocessed task data of the same users to be learned while aligning time-series positions; and
generating a learned analysis model by learning an analysis model having a neural network structure constructed in advance using the feature data and present bias data regarding a plurality of the users to be learned.

5. (canceled)

6. A present bias analysis device comprising processing circuitry configured to:
acquire a vital data series, a behavior data series, and a task data series of a user to be estimated;
perform predetermined preprocessing on each of the acquired vital data series, the acquired behavior data series, and the acquired task data series;
generate feature data regarding the user to be estimated by combining the preprocessed vital data series, the preprocessed behavior data series, and the preprocessed task data series while aligning time-series positions; and
input the feature data regarding the user to be estimated to a present bias analysis model having a neural network structure learned using feature data for learning and present bias data regarding a plurality of users to be learned and obtain present bias estimation data of the user to be estimated from the present bias analysis model.

7. The present bias analysis device according to claim 6, wherein the processing circuitry is further configured to:
extract, from the feature data regarding the user to be estimated, time information represented in a plurality of units based on information indicating the time-series positions of the vital data series, the behavior data series, and the task data series and add the extracted time information to the feature data,
input the feature data to which the time information is added to the present bias analysis model.

8. The present bias analysis device according to claim 6, wherein the processing circuitry is configured to perform at least one of data conversion processing, aggregation processing, or interpolation processing on each of the acquired vital data series, the acquired behavior data series, and the acquired task data series according to characteristics of data series to be processed corresponding to the acquired vital data series, the acquired behavior data series, or the acquired task data series.

9.-10. (canceled)

11. The present bias analysis method according to claim 4, further comprising:
extracting, from the feature data, time information represented in a plurality of units based on information indicating the time-series positions of the vital data, the behavior data, and the task data;
adding the extracted time information to the feature data; and
learning the analysis model by reflecting temporal periodicity of the feature data using the feature data to which the time information is added and the present bias data.

12. The present bias analysis method according to claim 4, wherein the performing the predetermined preprocessing performs at least one of data conversion processing, aggregation processing, or interpolation processing on each of the acquired vital data, the acquired behavior data, and the acquired task data according to characteristics of data to be processed corresponding to the acquired vital data, the acquired behavior data, or the acquired task data.
